(19) United States
(12) Patent Application Publication
(10) Pub. No.: US 2025/0079060 A1
(43) Pub. Date: Mar. 6, 2025

(54) COIL COMPONENT

(71) Applicant: SAMSUNG ELECTRO-MECHANICS CO., LTD., Suwon-si (KR)

(72) Inventors: Tae Hyun KIM, Suwon-si (KR); Byeong Cheol MOON, Suwon-si (KR); Dong Jin LEE, Suwon-si (KR); Dong Hwan LEE, Suwon-si (KR); Dae Ki LIM, Suwon-si (KR); Boum Seock KIM, Suwon-si (KR)

(73) Assignee: SAMSUNG ELECTRO-MECHANICS CO., LTD., Suwon-si (KR)

(21) Appl. No.: 18/773,966

(22) Filed: Jul. 16, 2024

(30) Foreign Application Priority Data
Sep. 1, 2023 (KR) 10-2023-0116534

(51) Int. Cl. H01F 27/22; H01F 27/32

(52) U.S. Cl. CPC H01F 27/22; H01F 27/32

(57) ABSTRACT

A coil component according to an aspect of the present disclosure includes a coil component having a body including a first surface and a second surface opposing each other in a first direction, and a third surface and a fourth surface connecting the first surface to the second surface and opposing each other in a second direction; a coil disposed in the body; an external electrode disposed on the body and connected to the coil; and a first heat dissipation portion disposed on the first surface, wherein the body includes a groove disposed in a region between the first heat dissipation portion and the external electrode.

### CROSS-REFERENCE TO RELATED APPLICATION(S)

This application claims benefit of priority to Korean Patent Application No. 10-2023-0116534 filed on Sep. 1, 2023 in the Korean Intellectual Property Office, the disclosure of which is incorporated herein by reference in its entirety.

### BACKGROUND

### 1. Field

The present disclosure relates to a coil component.

### 2. Description of Related Art

An inductor, a coil component, may be a representative passive electronic component used in an electronic device along with a resistor and a capacitor.

As an electronic device has been designed to have high-performance and a reduced size, the number of electronic components used in an electronic device has increased and a size thereof has been reduced.

A high-capacity inductor may require a heat dissipation structure to effectively remove heat generated by high voltage and high current. When disposing a heat dissipation pad directly on a coil component, it may be important to prevent short circuits or current leakage between an external electrode and a heat dissipation pad.

### SUMMARY

An aspect of the present disclosure is to increase a heat dissipation effect by disposing a heat dissipation portion on a surface of a body of a coil component and to ensure insulating properties between an external electrode and the heat dissipation portion to prevent short circuit or current leakage.

Another aspect of the present disclosure is to reduce magnetic flux loss caused by disposing a heat dissipation portion on a body.

According to an aspect of the present disclosure, a coil component includes a coil component having a body including a first surface and a second surface opposing each other in a first direction, and a third surface and a fourth surface connecting the first surface to the second surface and opposing each other in a second direction; a coil disposed in the body; an external electrode disposed on the body and connected to the coil; and a first heat dissipation portion disposed on the first surface, wherein the body includes a groove formed in a region between the first heat dissipation portion and the external electrode.

### BRIEF DESCRIPTION OF DRAWINGS

The above and other aspects, features, and advantages of the present disclosure will be more clearly understood from the following detailed description, taken in conjunction with the accompanying lead-outs, in which:

FIG. 1 is a perspective diagram illustrating a coil component according to a first embodiment of the present disclosure;

FIG. 2 is a cross-sectional diagram taken along line I-I′ in FIG. 1 and an enlarged diagram illustrating a groove and a recess region according to a second embodiment of the present disclosure;

FIG. 3 is a cross-sectional diagram taken along line II-II′ in FIG. 1;

FIG. 4 is a diagram illustrating the example illustrated in FIG. 1, viewed from below;

FIG. 5 is a diagram illustrating a coil component according to a second embodiment of the present disclosure, corresponding to FIG. 2;

FIG. 6 is a diagram illustrating a coil component of a modified example of a second embodiment of the present disclosure, corresponding to FIG. 5;

FIG. 7 is a diagram illustrating a coil component according to a third embodiment of the present disclosure, corresponding to FIG. 2; and

FIG. 8 is a diagram illustrating a coil component according to a fourth embodiment of the present disclosure, corresponding to FIG. 2.

### DETAILED DESCRIPTION

Hereinafter, embodiments of the present disclosure will be described as follows with reference to the attached drawings.

The present disclosure may, however, be exemplified in many different forms and should not be construed as being limited to the specific embodiments set forth herein. An expression used in the singular encompasses the expression of the plural, unless it has a clearly different meaning in the context. The terms, “include,” “comprise,” “is configured to,” or the like of the description are used to indicate the presence of features, numbers, steps, operations, elements, portions or combination thereof, and do not exclude the possibilities of combination or addition of one or more features, numbers, steps, operations, elements, portions or combination thereof. Also, the expression that an element is disposed “On” may indicate that the element may be disposed above or below a target portion, and does not necessarily indicate the element is disposed above the target portion in the direction of gravity.

It will be understood that when an element is “coupled with/to” or “connected with” another element, the element may be directly coupled with/to another element, and there may be an intervening element between the element and another element. To the contrary, it will be understood that when an element is “directly coupled with/to” or “directly connected to” another element, there is no intervening element between the element and another element.

The structures, shapes, and sizes described as examples in embodiments in the present disclosure may be implemented in another exemplary embodiment without departing from the spirit and scope of the present disclosure.

In the drawings, the T direction may be defined as a first direction or a thickness direction, the L direction may be defined as a second direction or a length direction, and the W direction may be defined as a third direction or a width direction.

In the drawings, same elements will be indicated by same reference numerals. Also, redundant descriptions and detailed descriptions of known functions and elements that may unnecessarily make the gist of the present disclosure obscure will not be provided.

Various types of electronic components are used in electronic devices, and various types of coil components may be appropriately used between these electronic components for the purpose of removing noise.

That is, in electronic devices, a coil component may be used as a power inductor, a HF inductor, a general bead, a GHz bead, a common mode filter, or the like.

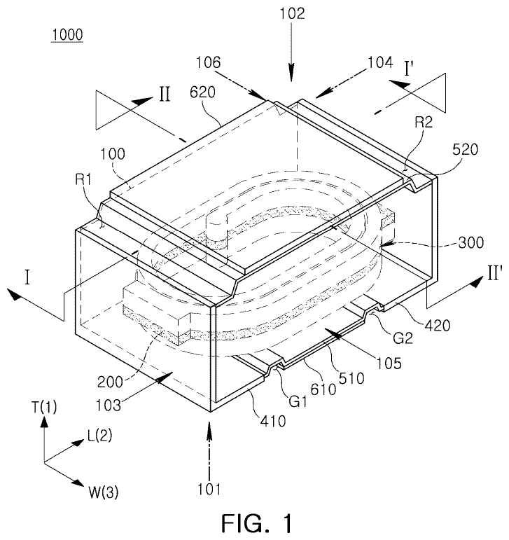

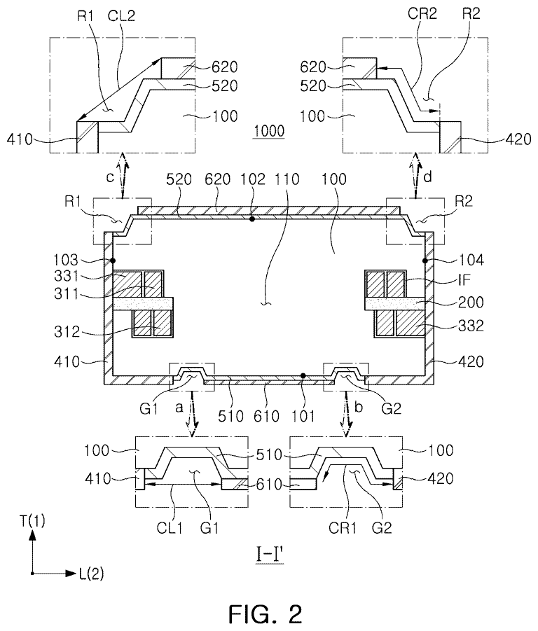

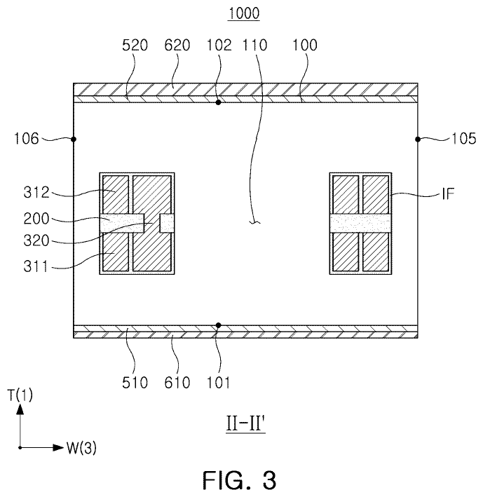

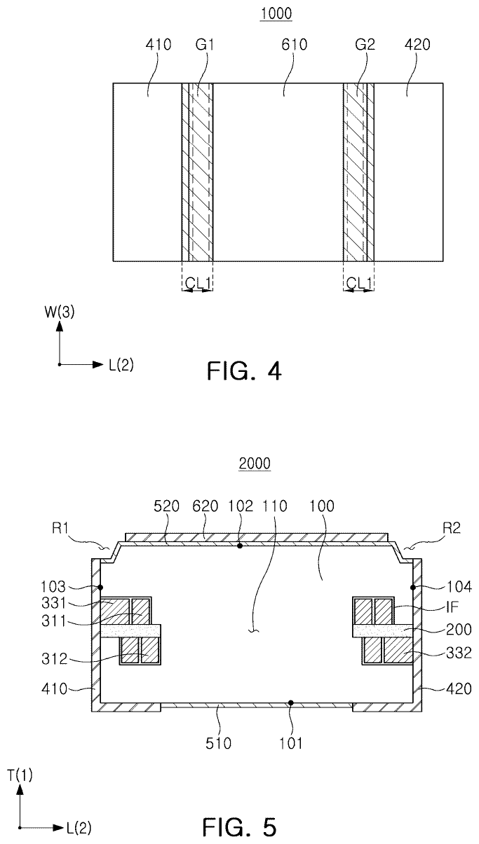

FIG. 1 is a perspective diagram illustrating a coil component according to a first embodiment. FIG. 2 is a cross-sectional diagram taken along line I-I′ in FIG. 1 and an enlarged diagram illustrating a groove and a recess region according to a second embodiment. FIG. 3 is a cross-sectional diagram taken along line II-II′ in FIG. 1. FIG. 4 is a diagram illustrating the example illustrated in FIG. 1, viewed from below.

Referring to FIGS. 1 to 4, a coil component 1000 according to the first embodiment may include a body 100, a coil 300, external electrodes 410 and 420, and heat dissipation portions 610 and 620, and may further include insulating layers 510 and 520 and a support member 200.

In the coil component 1000 according to the embodiment, the heat dissipation portions 610 and 620 disposed on the first surface 101 or the second surface 102 of the body 100 may be disposed, such that heat generated in the coil component 1000 when energized may be swiftly dissipated to the outside.

Also, by disposing grooves G1 and G2 or recesses R1 and R2 in a region between the external electrodes 410 and 420 disposed on the body 100 and the heat dissipation portion 610 and 620, clearance and creepage may be ensured, such that the risk of short circuit or current leakage between the external electrodes 410 and 420 and the heat dissipation portions 610 and 620 may be reduced.

Here, clearance may refer to a shortest distance across the air between two adjacent conductors, and creepage may refer to a shortest distance along an insulating material surface between two adjacent conductors. Clearance and creepage may be indicators of insulation reliability.

In the coil component 1000 according to the embodiment, the first heat dissipation portion 610 may be disposed on the first surface 101 corresponding to the mounting surface of the body 100, and the grooves G1 and G2 may be disposed between both ends of the first heat dissipation portion 610 and the adjacent external electrodes 410 and 420, such that the excellent heat dissipation effect and insulation reliability may be ensured.

Also, by disposing the second heat dissipation portion 620 on the second surface 102 corresponding to an upper surface of the body 100, and disposing the recesses R1 and R2 between the external electrodes 410 and 420 adjacent to both ends of the second heat dissipation portion 620, such that the dissipation effect and insulation reliability may be improved.

In the description below, main components included in the coil component 1000 according to the embodiment will be described in greater detail.

The body 100 may form an exterior of the coil component 1000 in the embodiment, and the coil 300 and the support member 200 may be embedded therein.

The body 100 may have a hexahedral shape.

The body 100 may include a first surface 101 and a second surface 102 opposing each other in the thickness direction (T, the first direction), a third surface 103 and a fourth surface 104 opposing each other in the length direction (L, the second direction), and a fifth surface 105 and a sixth surface 106 opposing each other in the width direction (W, the third direction). Each of the first to fourth surfaces 101, 102, 103 and 104 of the body 100 may be a wall surface of the body 100 connecting the first surface 101 and the second surface 102 of the body 100.

The body 100 may be formed such that the coil component in which the external electrodes 400 and 500 are formed may have a length of 2.5 mm, a width of 2.0 mm and a thickness of 0.8 mm, may have a length of 2.0 mm, a width of 1.2 mm and a thickness of 0.6 mm, may a length of 1.6 mm, a width of 0.8 mm and a thickness of 0.6 mm, may have a length of 1.6 mm, a width of 0.8 mm and a thickness of 0.6 mm, may have a length of 1.6 mm, a width of 0.8 mm and a thickness of 0.4 mm, may have a length of 1.4 mm, a width of 1.2 mm and a thickness of 0.65 mm, may have a length of 1.0 mm, a width of 0.7 mm and a thickness of 0.65 mm, may have a length of 0.8 mm, a width of 0.4 mm and a thickness of 0.65 mm, or may have a length of 0.8 mm, a width of 0.4 mm and a thickness of 0.5 mm, but an embodiment thereof is not limited thereto. As the above-described exemplary dimensions for the length, width and thickness of coil component 1000 may refer to dimensions not reflecting process errors, dimensions in the range recognized as process errors may correspond to the above-described example dimensions.

The length of the above-described coil component 1000 may be a maximum value among dimensions of a plurality of line segments connecting two outermost boundary lines of the coil component 1000, opposing each other in the length direction L, to each other and in parallel to the length direction L, with respect to an optical microscope image or a scanning electron microscope (SEM) image with respect to a cross-section in the length direction L-thickness direction T taken from the central portion of the coil component 1000 taken in the width direction W. Alternatively, the length of the coil component 1000 may refer to a minimum value among the dimensions of the plurality of line segments described above. Alternatively, the length of the coil component 1000 may refer to an arithmetic mean value of at least three or more of the dimensions of the plurality of line segments described above. Here, the plurality of line segments parallel to the length direction L may be spaced apart from each other by an equal distance in the thickness direction T, but an embodiment thereof is not limited thereto.

The thickness of the above-described coil component 1000 be a maximum value among dimensions of a plurality of line segments connecting two outermost boundary lines of the coil component 1000, opposing each other in the thickness direction T, to each other and in parallel to the thickness direction T, with respect to an optical microscope image or a scanning electron microscope (SEM) image with respect to a cross-section in the length direction L-thickness direction T taken from the central portion of the coil component 1000 taken in the width direction W. Alternatively, the thickness of the coil component 1000 may refer to a minimum value among the dimensions of the plurality of line segments described above. Alternatively, the thickness of the coil component 1000 may refer to an arithmetic mean value of at least three or more of the dimensions of the plurality of line segments described above. Here, the plurality of line segments parallel to the thickness direction T may be spaced apart from each other by an equal distance in the length direction L, but an embodiment thereof is not limited thereto.

The width of the above-described coil component 1000 may be a maximum value among dimensions of a plurality of line segments connecting two outermost boundary lines of the coil component 1000, opposing each other in the width direction W, to each other and in parallel to the width direction W, with respect to an optical microscope image or a scanning electron microscope (SEM) image with respect to a cross-section in the length direction L-width direction W taken from the central portion of the coil component 1000 taken in the thickness direction T. Alternatively, the width of the coil component 1000 may refer to a minimum value among the dimensions of the plurality of line segments described above. Alternatively, the width of the coil component 1000 may refer to an arithmetic mean value of at least three or more of the dimensions of the plurality of line segments described above. Here, the plurality of line segments parallel to the width direction W may be spaced apart from each other by an equal distance in the length direction L, but an embodiment thereof is not limited thereto.

Alternatively, each of the length, a width and thickness of the coil component 1000 may be measured by a micrometer measurement method. The micrometer measurement method may be of determining a zero point with a gage repeatability and reproducibility (R&R) micrometer, inserting the coil component 1000 in the embodiment between tips of the micrometer, and measuring by turning a measuring lever of a micrometer. In measuring the length of the coil component 1000 by the micrometer measurement method, the length of the coil component 1000 may refer to a value measured once or may refer to an arithmetic average of values measured a plurality of times, which may be equally applied to the width and thickness of the coil component 1000.

The body 100 may include a magnetic material and resin. Specifically, the body 100 may be formed by laminating one or more magnetic composite sheets in which a magnetic material is dispersed in an insulating resin. The body 100 may have a structure other than a structure in which a magnetic material is dispersed in resin. For example, the body 100 may be formed of a magnetic material such as ferrite.

The magnetic material may be ferrite or metallic magnetic powder.

A ferrite powder may be at least one of, for example, spinel-type ferrite such as Mg—Zn-based ferrite, Mn—Zn-based ferrite, Mn—Mg-based ferrite, Cu—Zn-based ferrite, Mg—Mn—Sr-based ferrite, Ni—Zn-based ferrite, hexagonal ferrites such as Ba—Zn-based ferrite, Ba—Mg-based ferrite, Ba—Ni-based ferrite, Ba—Co-based ferrite, Ba—Ni—Co-based ferrite, garnet-type ferrites such as Y-based ferrite, and Li-based ferrites.

A magnetic metal powder may include one or more selected from a group consisting of iron (Fe), silicon (Si), chromium (Cr), cobalt (Co), molybdenum (Mo), aluminum (Al), niobium (Nb), copper (Cu) and nickel (Ni). For example, the magnetic metal powder may be at least one of pure iron powder, Fe—Si alloy powder, Fe—Si—Al alloy powder, Fe—Ni alloy powder, Fe—Ni—Mo alloy powder, Fe—Ni—Mo—Cu alloy powder, Fe—Co alloy powder, Fe—Ni—Co alloy powder, Fe—Cr alloy powder, Fe—Cr—Si alloy powder, Fe—Si—Cu—Nb alloy powder, Fe—Ni—Cr-based alloy powder and Fe—Cr—Al alloy powder.

The magnetic metal powder may be amorphous or crystalline. For example, the magnetic metal powder may be a Fe—Si—B—Cr amorphous alloy powder, but an embodiment thereof is not limited thereto.

Each particle of ferrite and magnetic metal powder may have an average diameter of about 0.1 μm to 30 μm, but an embodiment thereof is not limited thereto. The body 100 may include two or more types of magnetic materials dispersed

in a resin. Here, the different types of magnetic materials may indicate that the magnetic materials dispersed in the resin may be distinguished from each other by one of an average diameter, composition, crystallinity, and shape.

The resin may include epoxy, polyimide, a liquid crystal polymer, or the like, alone or in combination but an embodiment thereof is not limited thereto.

Referring to FIGS. 2 and 3, the body 100 may include a core 110 penetrating through the support member 200 and the coil 300. The core 110 may be formed by filling the through-hole in the support member 200 and the coil 300 with a magnetic composite sheet, but an embodiment thereof is not limited thereto.

Referring to FIGS. 1, 2, and 4, the coil component 1000 according to the embodiment may include the grooves G1 and G2 disposed on the first surface 101 of the body 100.

The grooves G1 and G2 in the embodiment may be configured to increase insulation reliability of the coil component 1000 by improving creepage between the first heat dissipation portion 610 and the external electrodes 410 and 420.

Specifically, the first external electrode 410 and the second external electrode 420 may be spaced apart from each other on the first surface 101 of the body 100, and the first heat dissipation portion 610 may be disposed in a region between the first external electrode 410 and the second external electrode 420.

In the first surface 101 of the body 100, a first groove G1 may be disposed in a region between the first heat dissipation portion 610 and the first external electrode 410, and a second groove may be disposed in a region between the second heat dissipation portion 620 and the second external electrode 420.

In the embodiment, a structure including both the first groove G1 and the second groove G2 is illustrated, but the structure is not limited thereto, and only one of the first groove G1 and the second groove G2 may be included.

Referring to the enlarged diagram a and enlarged diagram b in FIG. 2, in the embodiment, the creepage CR1 between the first heat dissipation portion 610 and the external electrodes 410 and 420 may be larger than the clearance CL1 between the first heat dissipation portion 610 and the external electrodes 410 and 420.

This may be due to the structure in which the grooves G1 and G2 are diposed on the first surface 101 of the body 100. When the grooves G1 and G2 are not disposed, the creepage between the first heat dissipation portion 610 and the external electrodes 410 and 420 may have the same value as the clearance CL1 between the first heat dissipation portion 610 and the external electrodes 410 and 420.

According to the coil component 1000 according to the embodiment, as compared to the example in which there are no grooves G1 and G2, the clearance CL1 may be the same but the creepage CR1 may be larger, such that a length of a current leakage path along the surface may increase, and insulation reliability may be improved.

Referring to FIGS. 1 and 2, the grooves G1 and G2 may be disposed on the first surface 101 of the body 100 and may be inwardly recessed into the body 100.

Also, each of the grooves G1 and G2 may be disposed parallel to the third direction W. That is, the first groove G1 and the second groove G2 may be spaced apart from each other in the second direction L and may extend to the fifth surface 105 and sixth surface 106 of the body 100, respectively, in a linear line.

Also, side surfaces of the grooves G1 and G2 may be inclined. That is, each of the grooves G1 and G2 may have a tapered shape having a cross-sectional area increasing from an inner side to an outer side of the body 100.

Due to the shape of the grooves G1 and G2, the first insulating layer 510 may be conformally disposed when the first insulating layer 510, which will be described later, is disposed in the grooves G1 and G2, and accordingly, the creepage CR1 along the surface of the first insulating layer 510 between the first heat dissipation portion 610 and external electrodes 410 and 420 may be easily ensured.

However, the shape of the grooves G1 and G2 in the embodiment is not limited to the above-described shape, and the side surfaces of the grooves G1 and G2 may have a shape perpendicular to the first surface 101 of the body 100, and the groove G1 AND G2 may be formed to have a surface that is arch-shaped.

The grooves G1 and G2 may be disposed by removing a portion of the first surface 101 of the body 100 using a dicing tip, or the body 100 including the grooves G1 and G2 may be formed using a mold. In this case, a depth or a width of the grooves G1 and G2 may be adjusted to ensure the creepage necessary for insulating the coil component 1000.

Referring to FIGS. 1 and 2, the coil component 1000 according to the embodiment may include the recesses R1 and R2 disposed in a region between the second heat dissipation portion 620 disposed on the second surface 102 of the body 100 and the external electrodes 410 and 420.

The recesses R1 and R2 in the embodiment may be disposed in a corner region of the second surface 102 of the body 100, and by disposing a spacing region between the second heat dissipation portion 620 and the external electrodes 410 and 420, insulation reliability may be improved, and plating bleeding on the external electrodes 410 and 420 may be prevented.

The recesses R1 and R2 may be disposed in at least one corner region between the second surface 102 and the third surface 103 of the body 100, and the corner region between the second surface 102 and the fourth surface 104 of the body 100.

Specifically, the first recess R1 may be disposed in the corner region between the second surface 102 and the third surface 103 of the body 100 and may separate the second heat dissipation portion 620 and the first external electrode 410 from each other. The second recess R2 may be formed in the corner region between the second surface 102 and the third surface 103 of the body 100, and may separate the second heat dissipation portion 620 and the second external electrode 420 from each other.

In the embodiment, a structure including both the first recess R1 and the second recess R2 is illustrated, but the structure is not limited thereto and only one of the first recess R1 and the second recess R2 may be included.

Referring to the enlarged diagram c and enlarged diagram d in FIG. 2, in the embodiment, a creepage CR2 between the second heat dissipation portion 620 and the external electrodes 410 and 420 may be larger than a clearance CL2 between the second heat dissipation portion 620 and the external electrodes 410 and 420.

If the second heat dissipation portion 620 is disposed on the entire second surface 102 of the body 100 and there are no recesses R1 and R2, ensuring a clearance and a creepage between the second heat dissipation portion 620 and the external electrodes 410 and 420 may be difficult, such that there may be a risk of short circuit or current leakage along the surface.

Also, considering the example in which the coil component 1000 is directly connected to a heat sink included in the circuit board without the second heat dissipation portion 620, the clearance may be the same as compared to the example in which there are no recesses R1 and R2, but a creepage due to disposing the recesses R1 and R2 may be ensured, such that a length of a current leakage path along the surface may be increased, and insulation reliability may be improved.

Referring to FIGS. 1 and 2, the recesses R1 and R2 may be disposed in the corner region of the second surface 102 of the body 100 and may be inwardly recessed into the body 100.

Also, each of the recesses R1 and R2 may be disposed parallel to the third direction W. That is, the first recess R1 and the second recess R2 may be spaced apart from each other in the second direction L, and may extend to the fifth surface 105 and the sixth surface 106 of the body 100, respectively.

Also, side surfaces of the recesses R1 and R2 may be inclined. That is, each of the recesses R1 and R2 may have a tapered shape having a cross-sectional area having a width increasing from an inner side to an outer side of the body 100.

Due to the shape of the recess R1 and R2, when the second insulating layer 520, which will be described later, is disposed in the recess R1 and R2, the second insulating layer 520 may be conformally disposed, and accordingly, the creepage CR2 along the surface of the second insulating layer 520 between the second heat dissipation portion 620 and the external electrodes 410 and 420 may be easily ensured.

However, the shape of the recesses R1 and R2 in the embodiment is not limited to the above-described shapes, and the side surfaces of the recesses R1 and R2 may have a shape perpendicular to the second surface 102 of the body 100, and the recesses R1 and R2 may be disposed to have an arc-shaped curved surface.

The recesses R1 and R2 may be disposed by performing pre-dicing on one surface of a coil bar along a conceptual boundary line matching the third direction W of each coil component among conceptual boundary lines individualizing each coil component at the coil bar level before each coil component is individualized. However, an embodiment thereof is not limited thereto, and the body 100 including the recesses R1 and R2 may be formed by a mold.

In this case, a depth or a width of the recesses R1 and R2 may be adjusted such that the creepage required for insulation of coil component 1000 may be ensured.

The support member 200 may be disposed in the body 100 and may have one surface and the other surface facing each other. With respect to the direction in FIG. 1, one surface of the support member 200 may correspond to an upper surface, and the other surface of the support member 200 may correspond to a lower surface.

The support member 200 may be a component supporting the coil 300. Referring to FIG. 2, the support member 200 may support a first coil portion 311 and a first lead-out portion 331 disposed on one surface, and a second coil portion 312 and a second lead-out portion 332 disposed on the other surface.

The support member 200 may be excluded in embodiments, such as when the coil 300 corresponds to a wound coil or has a coreless structure.

The support member 200 may be formed of a thermosetting insulating resin such as an epoxy resin, a thermoplastic insulating resin such as polyimide, or an insulating material including a photosensitive insulating resin, or an insulating material in which the insulating resin is impregnated with a reinforcing material such as glass fiber or inorganic filler. For example, the support member 200 may be formed of an insulating material such as prepreg, Ajinomoto build-up film (ABF), FR-4, bismaleimide triazine (BT) film, and photo imaginable dielectric (PID) film, but an embodiment thereof is not limited thereto.

As inorganic fillers, at least one selected from a group consisting of silica (SiO₂), alumina (Al₂O₃), silicon carbide (SiC), barium sulfate (BaSO₄), talc, mud, mica powder, aluminum hydroxide (Al(OH)₃), magnesium hydroxide (Mg(OH)₂), calcium carbonate (CaCO₃), magnesium carbonate (MgCO₃), magnesium oxide (MgO), boron nitride (BN), aluminum borate (AlBO₃), barium titanate (BaTiO₃) and calcium zirconate (CaZrO₃) may be used.

When the support member 200 is formed of an insulating material including a reinforcing material, the support member 200 may provide improved rigidity. When the support member 200 is formed of an insulating material not including glass fibers, a thickness of a component may be easily reduced by reducing an overall thickness of the support member 200 and the coil 300 (indicating a sum of dimensions of the coil 300 and the support member 200 in the first direction T in FIG. 1). When the support member 200 is formed of an insulating material including a photosensitive insulating resin, the number of processes for forming the coil 300 may be reduced, which may be advantageous in reducing production costs, and a fine via 320 may be formed. The thickness of the support member 200 may be, for example, 10 μm or more and 50 μm or less, but an embodiment thereof is not limited thereto.

The coil 300 may be embedded in the body 100 and may exhibit characteristics of a coil component. For example, when the coil component 1000 according to the embodiment is used as a power inductor, the coil 300 may function to stabilize power of the electronic device by storing an electric field as a magnetic field and maintaining an output voltage.

The coil 300 may include the first and second coil portions 311 and 312, a via 320, and the first and second lead-out portions 331 and 332.

Referring to FIG. 2, with respect to the direction in FIG. 2, the first coil portion 311 and the first lead-out portion 331 may be disposed on one surface (an upper surface) of the support member 200 opposing the second surface 102 of the body 100. The second coil portion 312 and the second lead-out portion 332 may be disposed on the other surface (a lower surface) of the support member 200 opposing the first surface 101 of the body 100.

Referring to FIGS. 1 and 2, the first coil portion 311 may be disposed on one surface of the support member 200 and may form at least one turn centered on the core 110, and the outermost turn may extend and may be in contact with and connected to the first lead-out portion 331. The first coil portion 311 may have a planar helical shape, but an embodiment thereof is not limited thereto, and the first coil portion 311 may also have an angled shape.

The first lead-out portion 331 may be disposed on one surface of the support member 200 and may extend from an outermost turn of the first coil portion 311 to the third surface 103 of the body 100. The first lead-out portion 331 may be exposed to the third surface 103 of the body 100 and may be connected to the first external electrode 410.

The second coil portion 312 may be disposed on the other surface of the support member 200 and may form at least one turn centered on the core 110, and the outermost turn may extend to be in contact with the second lead-out portion 332. The second coil portion 312 may have a planar helical shape, but an embodiment thereof is not limited thereto, and the second coil portion 312 may also have an angled shape.

The second lead-out portion 332 may be disposed on the other surface of the support member 200 and may be disposed to extend from the outermost turn of the second coil portion 312 to the fourth surface 104 of the body 100. The second lead-out portion 332 may be exposed to the fourth surface 104 of the body 100 and may be connected to the second external electrode 420.

Referring to FIG. 3, the via 320 may be a component connecting the first and second coil portions 311 and 312 disposed on both surfaces of the support member 200 to each other. Specifically, the via 320 may penetrate the support member 200 and may connect ends of the innermost turns of the first and second coil portions 311 and 312 to each other.

Consequently, a signal input to the first external electrode 410 may be output to the second external electrode 420 through the first lead-out portion 331, the first coil portion 311, the via 320, the second coil portion 312, and the second lead-out portion 332. Through this structure, each component of coil 300 may function as a single coil connected between the first and second external electrodes 410 and 420.

At least one of the first and second coil portions 311 and 312, the via 320, and the first and second lead-out portions 331 and 332 may include one or more conductive layers. For example, when the first coil portion 311, the first lead-out portion 331, and the via 320 are formed by plating on an upper surface of the support member 200, each of the first coil portion 311, the first lead-out portion 331, and the via 320 may include a first conductive layer disposed by electroless plating, and a second conductive layer disposed on the first conductive layer.

The first conductive layer may be a seed layer for disposing a second conductive layer on the support member 200 by electroplating. The second conductive layer, disposed by electroplating, may have a single-layer structure or a multilayer structure. The second conductive layer having a multilayer structure may be formed as a conformal film structure in which one electroplating layer is covered by a third conductive layer, disposed by electroplating. The seed layer of the first coil portion 311 and the seed layer of the first lead-out portion 331 may be disposed integrally and a boundary may not be formed therebetween, but an embodiment thereof is not limited thereto. The electroplating layer of the first coil portion 311 and the electroplating layer of the first lead-out portion 331 may be integrally disposed such that no boundary may be disposed therebetween, but an embodiment thereof is not limited thereto.

Each of the first and second coil portions 311 and 312, the via 320, the first and second lead-out portions 331 and 332 may be formed of a conductive material such as copper (Cu), aluminum (Al), silver (Ag), tin (Sn), gold (Au), nickel (Ni), lead (Pb), titanium (Ti), or alloys thereof, but an embodiment thereof is not limited thereto.

Referring to FIGS. 2 and 3, the coil component 1000 according to the embodiment may further include an insulating film IF in the body 100.

The insulating film IF may insulate the coil portions 311 and 312 and the lead-out portions 331 and 332 from the body 100. The insulating film IF may include, for example, parylene, but an embodiment thereof is not limited thereto. The insulating film IF may be disposed using a method such as vapor deposition, but an embodiment thereof is not limited thereto, and may be disposed by laminating an insulating film on both surfaces of the support member 200. Meanwhile, the insulating film IF may have a structure including a portion of plating resist disposed on the coil 300 by electroplating, but an embodiment thereof is not limited thereto.

Referring to FIGS. 1 and 2, the first and second external electrodes 410 and 420 may be spaced apart from each other on the first surface 101 of the body 100, and the first external electrode 410 may extend to the third surface 103 of the body 100 and may be connected to the first lead-out portion 331. Also, the second external electrode 420 may extend to the fourth surface 104 of the body 100 and may be connected to the second lead-out portion 332.

The external electrode 410 and 420 may be formed of a conductive material such as copper (Cu), aluminum (Al), silver (Ag), tin (Sn), gold (Au), nickel (Ni), lead (Pb), chromium (Cr), titanium (Ti), or alloys thereof, but an embodiment thereof is not limited thereto.

The external electrodes 410 and 420 may be formed in a multilayer structure. For example, a first layer on which the external electrodes 410 and 420 are connected to the coil 300 may be a conductive resin layer including conductive powder including at least one of copper (Cu) and silver (Ag) and an insulating resin, or a copper (Cu) plating layer. Also, the second layer may have a double-layer structure of a nickel (Ni) plating layer and a tin (Sn) plating layer.

In this case, the first layer of the external electrodes 410 and 420 may be disposed by electroplating, vapor deposition such as sputtering, or may be disposed by applying and curing a conductive paste including a conductive powder such as copper (Cu) and/or silver (Ag). The second layer of external electrodes 410 and 420 may be disposed by electroplating.

Referring to FIGS. 1 to 3, the coil component 1000 according to the embodiment may include a first insulating layer 510 disposed between the first heat dissipation portion 610 and the body 100.

The first insulating layer 510 may be a component disposed on the first surface 101 of the body 100 and may insulate the surface of the body 100.

Both ends of the first insulating layer 510 may be disposed to be in contact with ends of the external electrodes 410 and 420, respectively, and at least a portion of the first insulating layer 510 may be disposed along surfaces of the grooves G1 and G2.

By extending at least a portion of the first insulating layer 510 to the surface of the grooves G1 and G2, insulation reliability between the first heat dissipation portion 610 and the external electrodes 410 and 420 may be improved.

Also, the coil component 1000 according to the embodiment may include a second insulating layer 520 disposed between the second heat dissipation portion 620 and the body 100.

The second insulating layer 520 may be a component disposed on the second surface 102 of the body 100 and may insulate the surface of the body 100.

Both ends of the second insulating layer 520 may be disposed to be in contact with ends of the external electrodes 410 and 420, respectively, and at least a portion of the second insulating layer 520 may be disposed along surfaces of the recesses R1 and R2.

By extending at least a portion of the second insulating layer 520 to the surfaces of the recesses R1 and R2, insulation reliability between the second heat dissipation portion 620 and the external electrodes 410 and 420 may be improved.

Although not illustrated in the diagram, an insulating layer for surface insulation may also be disposed on the fifth surface 105 and the sixth surface 106 of the body 100 illustrated in FIG. 1.

For example, the insulating layers 510 and 520 may be disposed by applying and curing an insulating material including an insulating resin to the surface of the body 100. In this case, the insulating layers 510 and 520 may include at least one of thermoplastic resins such as polystyrene resin, vinyl acetate resin, polyester resin, polyethylene resin, polypropylene resin, polyamide resin, rubber resin, and acrylic resin, thermosetting resins such as phenolic resin, epoxy resin, urethane resin, melamine resin, alkyd resin, or the like, and photosensitive resin.

Referring to FIGS. 1 to 4, the coil component 1000 according to the embodiment may include a first heat dissipation portion 610 disposed in a region between the first and second grooves G1 and G2 on the first surface 101 of the body 100.

Also, the coil component 1000 according to the embodiment may further include a second heat dissipation portion 620 disposed in a region between the first and second recesses R1 and R2 on the second surface 102 of the body 100.

The first and second heat dissipation portions 610 and 620 may function to radiate heat generated in the coil component 1000 to the outside when the coil component 1000 according to the embodiment is mounted on a circuit board and energized. The first and second heat dissipation portions 610 and 620 may include at least one of Cu, Ni, SiO2, SiC, SiN, carbon polymer, and resin to which a heat conductive filler is added.

FIG. 5 is a diagram illustrating a coil component according to a second embodiment, corresponding to FIG. 2.

As comparing FIG. 5 with FIG. 2, in a coil component 2000 according to the embodiment, the configurations in which there is no groove on the first surface 101 of the body 100, the first heat dissipation portion is not disposed, recesses R1 and R2 are only on the second surface 102 of the body 100, and the second heat dissipation portion 620 is disposed may be different.

Accordingly, in describing the embodiment, only the components of the first surface 101 of the body 100 different from the first embodiment will be described, and the description in the first embodiment may be applied to the other components in the embodiment.

Referring to FIG. 5, in the coil component 2000 according to the embodiment, the first heat dissipation portion may not be disposed on the first surface 101 of the body 100, and there may be no groove.

A first insulating layer 510 may be disposed in a region between the first and second external electrodes 410 and 420 on the first surface 101 of the body 100.

The coil component 2000 according to the embodiment may be advantageous in terms of component miniaturization through a structure not including the first heat dissipation portion and the groove, and the space for a magnetic material to be disposed in a limited size may be ensured, such that the effect of improving inductance due to an increase in effective volume may be obtained.

Also, when mounting the coil component 2000 on a circuit board, the risk of a short circuit occurring between the external electrodes 410 and 420 and the first heat dissipation portion 610 through solder may be prevented.

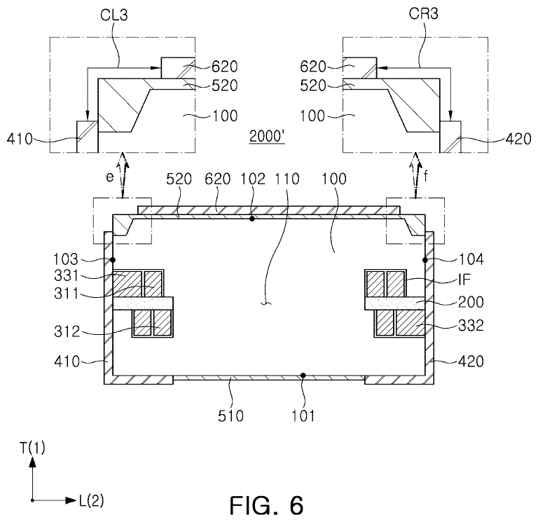

FIG. 6 is a diagram illustrating a coil component 2000′ according to a modified example of a second embodiment, corresponding to FIG. 5.

As comparing FIG. 6 with FIG. 2, in the coil component 2000′ according to the modified example, a second insulating layer 520 may fill recesses R1 and R2, and accordingly, the clearance CL3 and the creepage CR3 between the external electrodes 410 and 420 and the second heat dissipation portion 620 may be different from the second embodiment.

Accordingly, in describing the modified example, the arrangement relationship between the second insulating layer 520 and the recesses R1 and R2, which is different from the second embodiment, and changes in the clearance CL3 and the creepage CR3 between the external electrodes 410 and 420 and the second heat dissipation portion 620 will be described, and the description in the second embodiment may be applied to the other components in the embodiment.

Referring to FIG. 6, the second insulating layer 520 in the embodiment may be disposed to fill the first and second recesses R1 and R2.

A side surface of the second insulating layer 520 filling the recesses R1 and R2 may be substantially coplanar with the third surface 103 or the fourth surface 104 of the body 100.

In other words, the side surface of the second insulating layer 520 filling the first recess R1 may be disposed to be substantially coplanar with the third surface 103 of the body 100, and the side surface may be disposed to be substantially coplanar with the fourth surface 103 of the body 100.

Here, the configurations in which the components are substantially coplanar with each other may indicate that the components may share substantially the same flat surface, including process errors.

By filling the corner region of the body 100 recessed due to the disposing of the recesses R1 and R2, the exterior of the coil component 2000′ may be improved, and as the thickness of the second insulating layer 520 disposed in the recess R1 and R2 increases, insulation reliability between the second heat dissipation portion 620 and the external electrodes 410 and 420 may also be improved.

In particular, referring to the enlarged diagram e and enlarged diagram f in FIG. 6, by the second insulating layer 520 disposed to fill the recesses R1 and R2, a creepage CR3 between the second heat dissipation portion 620 and the external electrodes 410 and 420 and also a clearance CL3 may also increase as compared to the second embodiment.

Accordingly, in the coil component 2000 according to the embodiment, by the second insulating layer 520 disposed to fill the recesses R1 and R2, the effect of preventing the risk of short circuit or current leakage between the second heat dissipation portion 620 and the external electrodes 410 and 420 may improve.

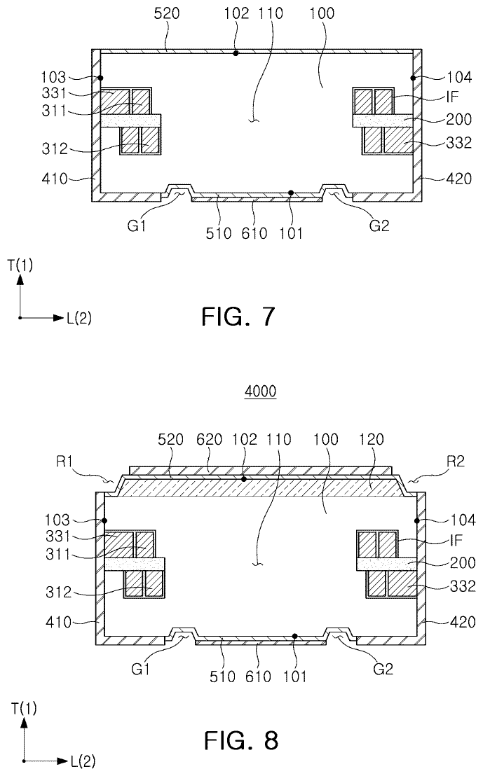

FIG. 7 is a diagram illustrating a coil component according to a third embodiment, corresponding to FIG. 2.

As comparing FIG. 7 with FIG. 2, in the coil component 3000 according to the embodiment, the configurations in which no recess is disposed on the second surface 102 of the body 100, the second heat dissipation portion is not disposed, grooves G1 and G2 are disposed only on the first surface 101 of body 100, and the first heat dissipation portion 610 is disposed may be different.

Accordingly, in describing the embodiment, only the components of the second surface 102 of the body 100, which are different from the first embodiment, will be described, and the description in the first embodiment may be applied to the other components in the embodiment.

Referring to FIG. 7, in the coil component 3000 according to the embodiment, the second heat dissipation portion may not be disposed on the second surface 102 of the body 100, and a recess may not be disposed.

A second insulating layer 520 may be disposed in a region between the first and second external electrodes 410 and 420 on the second surface 102 of the body 100.

The coil component 3000 according to the embodiment may be advantageous in terms of component miniaturization through a structure not including the second heat dissipation portion and the recess, and the space for the magnetic material to be disposed in a limited size may be ensured, the effect of improvement of inductance due to an increase in effective volume may be obtained.

Also, magnetic flux transition occurring when the second heat dissipation portion, which is a conductor, is disposed on the second surface 102 of the body 100 may be prevented.

FIG. 8 is a diagram illustrating a coil component 4000 according to a fourth embodiment, corresponding to FIG. 2.

As comparing FIG. 8 with FIG. 2, the coil component 4000 according to the embodiment may be different in that the coil component 4000 may include a high permeability portion 120 in an upper region of the body 100.

Accordingly, in describing the embodiment, only the high permeability portion 120 on the upper region of the body 100, different from the first embodiment, will be described, and the description in the first embodiment may be applied to the other components in the embodiment.

Referring to FIG. 8, the body 100 in the embodiment may further include a high permeability portion 120 disposed in a region adjacent to the second heat dissipation portion 620.

The high permeability portion 120 may function to prevent a decrease in inductance characteristics caused by transferring of a magnetic flux around the coil 300 as the second heat dissipation portion 620 is disposed as a conductor.

The high permeability portion 120 may include a material different from that of the other region of the body 100 and may include a material having a permeability higher than that of the other region of the body 100.

Also, the permeability of the high permeability portion 120 may be 5% or more higher than the permeability of the other regions of the body 100, but an embodiment thereof is not limited thereto.

Referring to FIG. 8, an interfacial surface may be disposed between the high permeability portion 120 and the other region of the body 100. However, the coil component 4000 according to the embodiment is not limited thereto, and depending on a method of disposing the high permeability portion 120, the component may be disposed integrally without an interfacial surface between the other regions of the body 100.

Also, at least a portion of the high permeability portion 120 may be covered by the second insulating layer 520.

According to the aforementioned embodiments, a coil component having a high heat dissipation effect when mounted on a circuit board and ensuring insulation reliability between the external electrode and the heat dissipation portion may be provided.

According to another aspect, by forming an upper portion of the body as a high permeability portion, loss of magnetic flux due to the heat dissipation portion disposed on an upper surface of the body may be reduced.

While the embodiments have been illustrated and described above, it will be apparent to those skilled in the art that modifications and variations could be made without departing from the scope of the present disclosure as defined by the appended claims.

What is claimed is:

1. A coil component, comprising:
a body including a first surface and a second surface opposing each other in a first direction, and a third surface and a fourth surface connecting the first surface to the second surface and opposing each other in a second direction;
a coil disposed in the body;
an external electrode disposed on the body and connected to the coil; and
a first heat dissipation portion disposed on the first surface,
wherein the body includes a groove disposed in a region between the first heat dissipation portion and the external electrode.

2. The coil component of claim 1, wherein the groove is disposed on the first surface and is inwardly recessed into the body.

3. The coil component of claim 1, wherein the groove is disposed parallel to a third direction perpendicular to each of the first direction and the second direction.

4. The coil component of claim 1, wherein a side surface of the groove is inclined.

5. The coil component of claim 1, wherein a first insulating layer is disposed between the first heat dissipation portion and the body.

6. The coil component of claim 5, wherein at least a portion of the first insulating layer is disposed along a surface of the groove.

7. The coil component of claim 1, wherein the first heat dissipation portion includes at least one of Cu, Ni, SiO2, SiC, SiN, carbon polymer, and resin to which a heat conductive filler is added.

8. The coil component of claim 1, further comprising:
a second heat dissipation portion disposed on the second surface,
wherein the body further includes a recess disposed in a region between the second heat dissipation portion and the external electrode.

9. The coil component of claim 8, wherein the recess is disposed in at least one of a corner region between the second surface and the third surface, and a corner region between the second surface and the fourth surface, and is inwardly recessed into the body.

10. The coil component of claim 8, wherein the recess is disposed parallel to a third direction perpendicular to each of the first direction and the second direction.

11. The coil component of claim 8, wherein a side surface of the recess is inclined.

12. The coil component of claim 8, wherein a second insulating layer is disposed between the second heat dissipation portion and the body.

13. The coil component of claim 12, wherein at least a portion of the second insulating layer is disposed along a surface of the recess.

14. The coil component of claim 13, wherein the second insulating layer is disposed to fill the recess.

15. The coil component of claim 8, wherein the second heat dissipation portion includes at least one of Cu, Ni, SiO2, SiC, SiN, carbon polymer, and resin to which a heat conductive filler is added.

16. The coil component of claim 12, wherein the body further includes a high permeability portion disposed in a region adjacent to the second heat dissipation portion.

17. The coil component of claim 16, wherein the high permeability portion includes a material having a permeability higher than that of the other region of the body.

18. The coil component of claim 16, wherein a permeability of the high permeability portion is at least 5% higher than a permeability of the other region of the body.

19. The coil component of claim 16, wherein an interfacial surface is disposed between the high permeability portion and the other region of the body.

20. The coil component of claim 16, wherein at least a portion of the high permeability portion is covered by the second insulating layer.
